(19) United States
(12) Patent Application Publication
(10) Pub. No.: US 2010/0325352 A1
(43) Pub. Date: Dec. 23, 2010

(54) HIERARCHICALLY STRUCTURED MASS STORAGE DEVICE AND METHOD

(75) Inventors: Franz Michael Schuette, Colorado Springs, CO (US); William J. Allen, Cupertino, CA (US)

Correspondence Address: HARTMAN & HARTMAN, P.C., 552 EAST 700 NORTH, VALPARAISO, IN, 46383, US

(73) Assignee: OCZ TECHNOLOGY GROUP, INC., San Jose, CA (US)

(21) Appl. No.: 12/815,661

(22) Filed: Jun. 15, 2010

Related U.S. Application Data
(60) Provisional application No. 61/218,571, filed on Jun. 19, 2009.

(51) Int. Cl. G06F 12/02; G06F 12/08; G06F 13/00

(52) U.S. Cl. 711/103; 711/118; 710/300; 711/E12.017; 711/E12.008

(57) ABSTRACT

A hierarchically-structured computer mass storage system and method. The mass storage system includes a mass storage memory drive, control logic on the mass storage memory drive that includes a controller and one or more devices for executing a hierarchical storage management technique, a volatile memory cache configured to be accessed by the control logic, and first and second non-volatile storage arrays on the mass storage memory drive and comprising, respectively, first and second non-volatile memory devices. The first and second non-volatile memory devices have properties including access times and write endurance, and at least one of the access time and the write endurance of the first non-volatile memory devices is faster or higher, respectively, than the second non-volatile memory devices. Desired data storage localities on the storage arrays are determined through access patterns and selectively utilizing the properties of the memory devices to match the data storage requirements.

### CROSS REFERENCE TO RELATED APPLICATIONS

This application claims the benefit of U.S. Provisional Application No. 61/218,571, filed Jun. 19, 2009, the contents of which are incorporated herein by reference.

### BACKGROUND OF THE INVENTION

The present invention generally relates to computer memory systems, and more particularly to a computer memory system comprising multi-tiered non-volatile memory in a hierarchical order.

Computer system memory systems are generally considered to include caches, volatile high speed memory and non-volatile mass storage memory. In most cases, the non-volatile mass storage memory is in the form of hard disk drives (HDD), comprising magnetic platters mounted on a spindle whereon data are accessed by positioning a read-write head over the logical block address consisting of a sector address and a track. On the back end of archives, tape drives, and particularly digital linear tapes (DLT), have provided ultra-high capacity storage at low price and low performance. Recent additions to this scheme are solid-state drives (SSDs), particularly SSDs using NAND flash memory. These SSDs are currently becoming a replacement for fast HDDs.

In addition to NAND flash, other memory technologies are emerging into the segment of non-volatile memory devices. Ferromagnetic memory (FRAM), magnetic memory (MRAM), phase change memory (PCM), resistive random access memory (R-RAM), and organic memories using, for example, multi-porphyrin molecules to trap electron charges, are among the most likely contenders for the next prevalent non-volatile memory technology, though other technologies are also within the scope of this invention. FRAM and PCM are currently the farthest along with respect to maturity, write endurance, speed and density, but compared to NAND flash the cost is still orders of magnitude higher.

Though current mass storage memory systems typically use a single form of non-volatile memory, conventional mass storage memory, including HDDs and SSDs, further rely on volatile memory, most commonly in the form of synchronous DRAM or pipe burst SRAM (PBS) as intermediate buffer or cache. In the case of writes to the drive, data can be consolidated in the cache to increase write efficiency. Likewise, in the case of reads, data can be prefetched based on queued read requests to ensure most efficient utilization of the buses. In certain aspects, this type of caching is a form of hierarchical storage. However, the currently employed form of caching is limited by the comparably very small amount of memory and, in addition, the cached data are not permanent but subject to maintenance of power to the device.

Though SSDs are starting to replace HDDs in current computer systems, like any other NAND-based device, they have limited data retention and write endurance. Current write endurance is specified typically at approximately five thousand write cycles, which, in theory, is enough for several years of life under normal usage patterns. However, in practice, two issues artificially inflate the number of writes. Firstly, NAND flash cannot be overwritten since bit changes can only occur from 1 to 0 but not the other way. Therefore each rewrite requires an erase cycle first in which the entire block is reset to 1 values for every bit. Secondly, the static mapping of memory pages within each NAND flash block causes rewriting of every block's content with any file update, which increases the number of actually written and erased bytes orders of magnitude over the number of byte updates needed. The combination of both factors increases the wear on NAND memory devices and also causes some significant slowing of SSDs once they start filling up with orphaned data that are simply unmanaged leftovers from previous updates without any pointers associated with them. Garbage collection and TRIM algorithms are being developed to proactively erase these blocks in order to recondition them to a pseudo-native unused state. This does not, however, solve the fundamental problem of limited write endurance and data retention as a cause of proximity write and read disturbance.

Depending on the total capacity of a HDD or SSD, 90-95% of all accesses are estimated to hit between 1 and 5% of the total drive's logical addresses in any given period of time. In particular, operating system files are accessed on every reboot and in between for system functionality very frequently. Likewise, program files are accessed very frequently. In the case of documents, “work in progress” is constantly saved either through autosave functionality or else through user-initiated save commands until a final version is established. Also, temporary files and meta data are constantly stored and then deleted or updated. Particularly those updates of small files, which include housekeeping of the operating system, add a substantial amount of stress to a NAND flash-based drive because each update requires a complete rewriting of a larger set of data, very often an entire block.

As mentioned above, the memory subsystem of any computer uses multiple tiers, including the processor cache levels, the system memory and a page file on the hard disk drive as an overflow buffer, and finally the hard disk drive or solid state drive as non-volatile mass storage device. Hard disk drives and solid state drives typically also include an internal or on-device cache for write-combining and prefetching of reads. In addition, hybrid drives like the Seagate Momentus are available, using a non-volatile, NAND flash-based large (256 MByte) intermediate cache for holding the most frequently accessed data whereas all other permanently stored data are written to a 120 GB rotating platter media in a 2.5 inch (about 6.35 cm) form factor.

### BRIEF DESCRIPTION OF THE INVENTION

The current invention provides a computer mass storage system comprising multi-tiered hierarchical-ordered non-volatile memory, which is in addition to a volatile cache of the type common to conventional HDDs and SSDs. The invention preferably makes use of hierarchical storage management (HSM) algorithms, which can be used to identify high frequency access patterns, the target files of which are then moved into a higher-speed, higher-endurance tier within the multi-tiered hierarchical-ordered non-volatile memory.

According to a first aspect of the invention, a mass storage system includes a mass storage memory drive, a control logic on the mass storage memory drive and configured to execute a hierarchical storage management technique, a volatile memory cache configured to be accessed by the control logic, and first and second non-volatile storage arrays on the mass storage memory drive and comprising, respectively, first and second non-volatile memory devices. The first and second non-volatile memory devices have properties including access times and write endurance, and at least one of the access time and the write endurance of the first non-volatile memory devices is faster or higher, respectively, than the second non-volatile memory devices.

According to a second aspect of the invention, a method of using the mass storage system includes operating the control logic to execute hierarchical storage management using the first and second non-volatile storage arrays to store data, including determining through an access pattern a locality on one of the first and second non-volatile storage arrays for storing the data thereon by utilizing the properties of the first and second non-volatile storage arrays to match storage requirements of the data. The data are then written to the locality on the first or second non-volatile storage array.

From the above, it can be appreciated that the first and second non-volatile storage arrays are effectively separate tiers of mass storage devices within the mass storage system. Preferred non-volatile memory devices for the first non-volatile storage array include, but are not limited to, solid-state memory devices such as phase change memory, nV SRAM, ferromagnetic memory (for example, FRAM), or any other suitable non-volatile memory characterized by relatively fast access times and high write endurances. The second non-volatile storage array can constitute a large array of non-volatile memory devices with relatively lower access times and write endurances and lower cost per bit, notable examples of which include solid-state memory devices such as flash memory in either NAND or NOR variation. An access monitoring circuitry captures the addresses and counts the frequency of all requests. If the number of requests for a specific set of data over a predetermined period of time exceeds a threshold, the data are copied from the second non-volatile storage array into the first non-volatile storage array. If the data in the first non-volatile storage array are modified, the modified data are preferably written back to the second non-volatile storage array. On the other hand, if the data are not modified and the access frequency drops below the threshold, the data can simply be invalidated and the next request will go back to the second non-volatile storage array. Alternatively, the data can be written back to the second non-volatile storage array upon expiration of the priority level.

A significant benefit of the heterogeneous, hierarchically-organized mass storage system of the present invention arises from the fact that, in view of the typically uneven distribution of accesses to a computer mass storage system, particularly with respect to small temporary file segments and their constant updates, the mass storage system uses different inceptions of solid-state memory as non-volatile portions of the data storage array. In this case, higher traffic areas of the physical memory space are serviced by one or more higher speed, higher write endurance devices with long data retention even if they come at a cost premium, whereas lower traffic areas of the physical memory space can be serviced by lower cost commodity devices that are less frequently written to.

In view of the above, nonlimiting advantages of the current invention can include the use of separate tiers of non-volatile memory to allow for customized data management depending on demand in a single drive, increased performance and endurance of the entire device, higher speed accesses and updates of the first tier of storage, and lower wear and less frequent disturbances for the second tier of storage.

Other aspects and advantages of this invention will be better appreciated from the following detailed description.

### BRIEF DESCRIPTION OF THE DRAWINGS

FIG. 1 shows a schematic representation of a hierarchically-organized mass storage device in accordance with an embodiment of the invention.

FIG. 2 shows a flow diagram of the hierarchical storage management of FIG. 1.

### DETAILED DESCRIPTION OF THE INVENTION

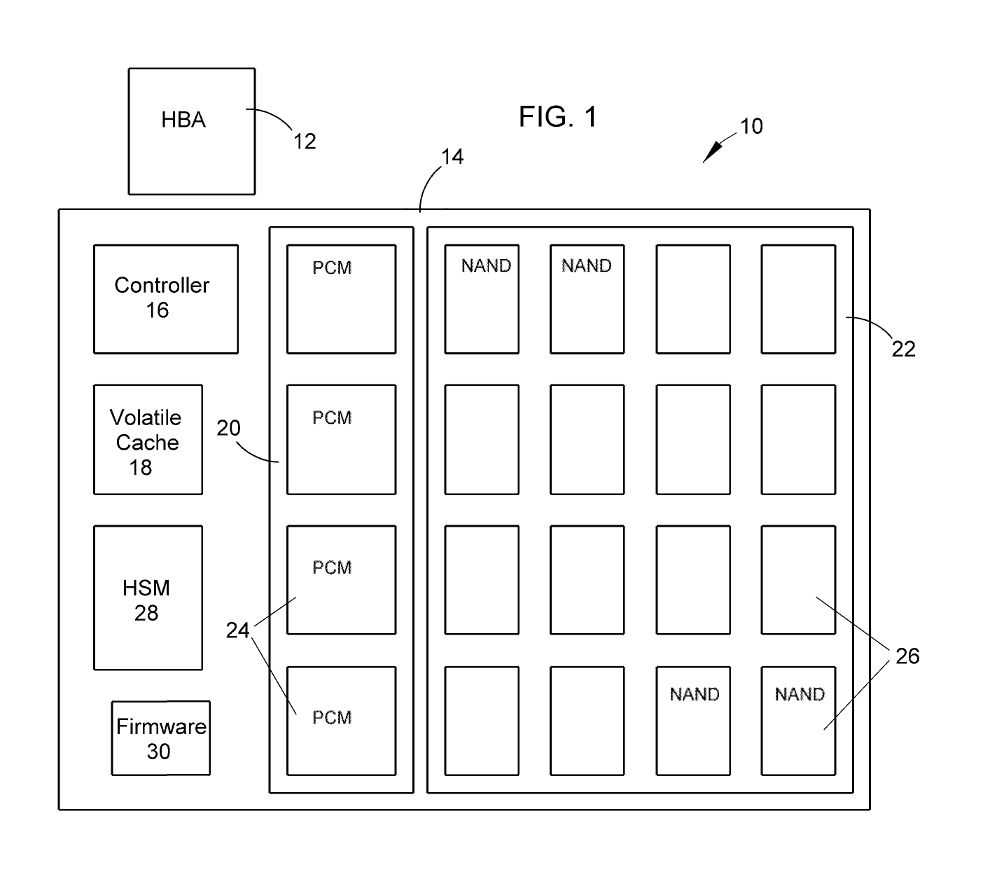

FIG. 1 schematically represents a hierarchically-organized mass storage system 10 suitable for use in a computer in accordance with an embodiment of the invention. A host bus adapter (HBA) 12 of the computer is represented as being adapted to interact with control logic on a non-volatile mass storage memory device, referred to herein as a drive 14. The control logic includes a controller 16 configured to access a volatile cache 18 and multiple discreet domains or tiers of memory, represented in FIG. 1 by first and second tiers 20 and 22 of memory containing arrays of non-volatile memory devices 24 and 26, respectively, on the drive 14. Memory technologies used within the tiers 20 and 22 are preferably solid-state memory devices, though other technologies are also possible, for example, microelectromechanical systems-based solutions and nanoelectromechanical systems. The non-volatile memory devices 24 and 26 of the tiers 20 and 22 are preferably different, such that the non-volatile memory on the drive 14 is heterogeneous. In the embodiment shown in FIG. 1, the memory devices 24 of the first tier 20 are represented as phase change memory (PCM) devices and the memory devices 26 of the second tier 22 are represented as NAND flash memory, though the use of other types of memory devices is also within the scope of this invention. In particular, a preferred aspect of the invention is that the devices 24 of the first tier 20 of memory are characterized by relatively fast access times and high write endurances, at least with respect to the devices 26 of the second tier 22 of memory. For this reason, in addition to PCM devices, nV SRAM and ferromagnetic memory (for example, FRAM) are believed to be particularly suitable non-volatile memory devices 24 for the first tier 20, whereas suitable memory technologies for the devices 26 of the second tier 22 include the NAND flash represented in FIG. 1, as well as NOR flash and other non-volatile memory devices that can be configured in a relatively large array. Notably, if NAND flash is used in the second tier 22, NOR flash may be used in the first tier 20 in view of its faster access time and higher endurance as compared to NAND flash. NAND flash has the additional advantage of having a relatively low cost per bit, such that the devices 26 of the second tier 22 are shown as forming a much larger array than the devices 24 of the first tier 20.

In addition to the controller 16, FIG. 1 further shows the control logic of the drive 14 as comprising a hierarchical storage management (HSM) unit 28. The HSM unit 28 preferably features access frequency monitoring functionality to determine priority levels of data being written onto and retrieved from the memory devices 24 and 26. The HSM unit can also perform intelligent operations such as logging usage patterns in order to prioritize data distribution to the first tier 20 or second tier 22. For example, in computer games with different maps, coherent maps can be speculatively pre-loaded from the second tier 22 into the first tier 20 during game play. The HSM unit 28 is further adapted to initiate a command sequence on the controller 16 to copy high priority data from the second tier 22 to the first tier 20 of memory. As a result of the hierarchical storage management performed with the memory devices 24 and 26 of the first and second tiers 20 and 22 of memory, the tiers 20 and 22 of memory on the drive 14 are hierarchically ordered and the drive 14 will be referred to as being hierarchically organized. Alternatively, some or all of the hierarchical storage management functionality can be performed either in embedded software or in firmware 30 on the drive 14. Another alternative is to allow software applications on the host computer to perform the HSM process.

In view of the above, it can be appreciated that the present invention is capable of increasing the performance of a solid-state drive by separating arrays of non-volatile mass storage memory devices 24 and 26 into two or more different tiers 20 and 22. The high performance non-volatile memory devices 24 of the first tier 20 preferably constitute a minority of the overall capacity of the drive 14, for example, approximately 0.5 to 5% of the capacity of the entire drive 14. High performance in this context means low access latency, high bandwidth, high endurance and high retention rate, though these factors have to be viewed relative to the equivalent factors of the second tier 22 of non-volatile memory devices 26. On the other hand, the non-volatile memory devices 26 of the second tier 22 are preferably lower in cost and constitute the majority (at least 95%) of the capacity of the overall capacity of the drive 14. Storage customization between the tiers 20 and 22 is based on request activity and achieved with the HSM unit 28 integrated onto the drive 14.

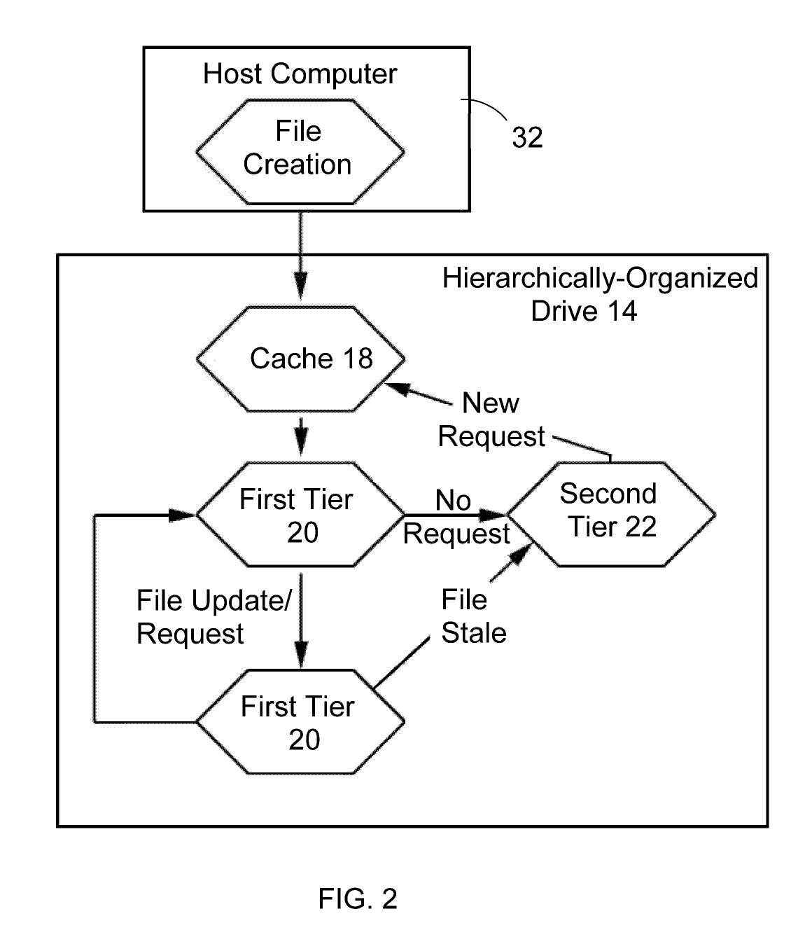

FIG. 2 represents a flow diagram of a hierarchical storage management process performed in accordance with an embodiment of the present invention. As represented in FIG. 2, after a file is created on a host computer 32, it is written to the hierarchically organized drive 14. After being buffered in the volatile cache 18, data are written to the first tier 20 of memory devices 24 in anticipation of updates and corrections as they occur during any content creation process. If those updates or corrections occur within a given time frame, the data are maintained in the first tier 20, which may include copying an updated file to a different location within the array of memory devices 24 of the first tier 20. Similarly, if there is a high request activity for the newly created data, the locality of the data is maintained in the first tier 20 until the request activity drops below a predefined threshold, at which point the data are considered stale. If no file accesses occur and the file becomes stale, it is moved to the second tier 22 of memory and its larger storage capacity.

If at any time the request activity for a given set of data stored in the second tier 22 increases beyond a predefined threshold, which can include a single request, the data are retrieved from the second tier 20 and copied to the first tier 20. Intermediate storage of the data in this case can involve the volatile cache 18 of the drive 14, which generally serves as a prefetch and write-combine buffer for the drive 14. For example, a given file may gain relevance through indexing in any reference index, for example, a news outlet in the case of the file being web content. Consequently, the demand for the specific file increases and the access frequency rises. After repeated accesses of the file, the access frequency exceeds the preset threshold for determining that the file is part of a high priority access pattern, and the HSM unit 28 therefore determines that a copy of the file needs to be stored in the first tier 20 of non-volatile memory. At the next access, which involves read-caching of the file in the volatile cache 18 of the drive 14, the file is not simply purged from the cache 18 but written back to the first tier 20 of memory. Alternatively, the address of the file can be flagged as high priority to initiate a direct copying of the file to the first tier 20 at the next access. In view of the different request activities desired for the tiers 20 and 22, different data path widths may be utilized. For example, the first tier 20 would preferably have a data path that is wider than that of the second tier 22 to enable higher bandwidth or alternatively running at a higher data rate but reduced number of channels compared to the non-volatile memory devices 26 (e.g., NAND flash) of the second tier 22.

A copy of the file's checksum can be maintained in the memory devices 24 of the first tier 20. If the request frequency drops below the threshold, the HSM unit 28 can compare the recent checksum of the file with the original checksum of the file in the first tier 20 or else the original checksum in the second tier 22 to determine whether any changes have occurred. If the file has been changed, the new file is written back to the second tier 22. If no changes have occurred, then the file is simply purged from the first tier 20. Alternatively, a time stamp comparison of the original copy to the first tier 20 and the final version that is about to expire can be used to determine changes in the file requiring write-back to the higher-level first tier 20.

According to another aspect of the invention, the invention can be integrated into a direct interface device, for example, a PCI (peripheral component interconnect) device such as a PCIe (PCI Express) expansion card, that directly interfaces with the system 10. In such an embodiment, the drive (expansion card) 14 can use a discrete on-board volatile cache (e.g., cache 18) or else access as bus master the system memory through a standard DMA (direct memory access) channel. Control logic located on a PCIe expansion card can directly interface with the PCIe bus and use an HSM logic to arbitrate between two non-volatile memory controllers, each having a local non-volatile memory domain corresponding to the first and second tiers 20 and 22, respectively, and also having access to a shared volatile cache (e.g., cache 18) located on the expansion card. In yet another embodiment, the HSM process can be performed on the system level and can be used to identify the memory domain corresponding to the first and second tiers 20 and 22 on the PCIe card. The system memory may be used as cache in this case to move data between the tiers 20 and 22.

While the invention has been described in terms of a specific embodiment, it is apparent that other forms could be adopted by one skilled in the art. For example, more than two tiers of memory arrays could be present on a single drive, and each tier could contain any number of memory devices. Furthermore, the functions of certain components could be performed by different components capable of similar (though not necessarily equivalent) function. Accordingly, it should be understood that the invention is not limited to the specific embodiment described and illustrated in the Figures. Therefore, the scope of the invention is to be limited only by the following claims.

1. A mass storage system comprising:
a mass storage memory drive;
control logic on the mass storage memory drive and comprising a controller and means for executing a hierarchical storage management technique;
a volatile memory cache configured to be accessed by the control logic; and
first and second non-volatile storage arrays on the mass storage memory drive and comprising, respectively, first and second non-volatile memory devices;
wherein the first and second non-volatile memory devices have properties comprising access times and write endurance, and at least one of the access time and the write endurance of the first non-volatile memory devices is faster or higher, respectively, than the second non-volatile memory devices.

2. The mass storage system of claim 1, wherein the hierarchical storage management technique is adapted to monitor the frequency of all requests of data and has a predetermined threshold for the monitored request frequencies, exceeding the request frequency threshold will result in prioritizing the requested data, and the prioritized data are copied from the second non-volatile storage array into the first non-volatile storage array.

3. The mass storage system of claim 2, wherein a copy of a file from the second non-volatile storage array to the first non-volatile storage array uses the volatile cache.

4. The mass storage system of claim 2, wherein the hierarchical storage management technique is adapted to determine de-prioritizing of data when a request frequency drops below the predetermined frequency.

5. The mass storage system of claim 4, wherein the hierarchical storage management technique is adapted to use a checksum comparison or a file time stamp to determine whether a file in the first non-volatile storage array has been modified and, if the file has been modified, writing the modified file back to the second non-volatile storage array.

6. The mass storage system of claim 5 wherein, if the file in the first non-volatile storage array has not been changed, the file is purged from the first non-volatile storage array without writing it back to the second non-volatile storage array.

7. The mass storage system of claim 1, wherein the executing means is configured to adapt to usage patterns to prioritize data distribution to the first and second non-volatile storage arrays.

8. The mass storage system of claim 1, wherein the first and second non-volatile memory devices comprise solid-state, microelectromechanical, or nanoelectromechanical memory devices.

9. The mass storage system of claim 1, wherein the first and second non-volatile memory devices comprise solid-state memory devices.

10. The mass storage system of claim 1, wherein the first non-volatile memory devices are PCM devices, nV SRAM, ferromagnetic or NOR memory devices and the second non-volatile memory devices are NAND or NOR memory devices.

11. The mass storage system of claim 1, wherein the volatile memory cache is located on the mass storage memory drive.

12. The mass storage system of claim 1, wherein the volatile memory cache is not located on the mass storage memory drive.

13. The mass storage system of claim 1, wherein the drive is a direct interface device.

14. The mass storage system of claim 13, wherein the direct interface device is a PCIe expansion card.

15. The mass storage system of claim 1, wherein the first non-volatile storage array has a wider data path than the second non-volatile storage array.

16. A method of using the mass storage system of claim 1, the method comprising:
operating the control logic and executing means to execute the hierarchical storage management technique and store data on the first and second non-volatile storage arrays, the operating step comprising determining through an access pattern a locality on one of the first and second non-volatile storage arrays for storing the data thereon by utilizing the properties of the first and second non-volatile memory devices to match storage requirements of the data;
writing the data to the locality on the first or second non-volatile storage array.

17. The method of claim 16, wherein the hierarchical storage management technique monitors the frequency of all requests of data and has a predetermined threshold for the monitored request frequencies, exceeding the request frequency threshold results in prioritizing the requested data, and the prioritized data are copied from the second non-volatile storage array into the first non-volatile storage array.

18. The method of claim 17, wherein a copy of a file from the second non-volatile storage array to the first non-volatile storage array uses the volatile cache.

19. The method of claim 17, wherein the hierarchical storage management technique determines de-prioritizing of data when a request frequency drops below the predetermined frequency.

20. The method of claim 19, wherein the hierarchical storage management technique uses a checksum comparison or a file time stamp to determine whether a file in the first non-volatile storage array has been modified and, if the file has been modified, writing the modified file back to the second non-volatile storage array.

21. The method of claim 20 wherein, if the file in the first non-volatile storage array has not been changed, the file is purged from the first non-volatile storage array without writing it back to the second non-volatile storage array.

22. The method of claim 16, wherein the executing means adapts to usage patterns to prioritize data distribution to the first and second non-volatile storage arrays.

23. The method of claim 16, wherein the first and second non-volatile memory devices comprise solid-state, microelectromechanical, or nanoelectromechanical memory devices.

24. The method of claim 16, wherein the first non-volatile memory devices are PCM devices, nV SRAM, ferromagnetic or NOR memory devices and the second non-volatile memory devices are NAND or NOR memory devices.

25. A computer in which the mass storage system of claim 1 is installed and performs the method of claim 16.

26. A mass storage system comprising:
a mass storage memory drive configured as a direct interface device;
control logic on the mass storage memory drive and comprising a controller and means for executing a hierarchical storage management technique;
a volatile memory cache configured to be accessed by the control logic; and
first and second non-volatile storage arrays on the mass storage memory drive and comprising, respectively, first and second non-volatile memory devices;
wherein the first and second non-volatile memory devices have properties comprising access times and write endurance, and at least one of the access time and the write endurance of the first non-volatile memory devices is faster or higher, respectively, than the second non-volatile memory devices.

27. The mass storage system of claim 26, wherein the direct interface device is a PCIe expansion card.
